(19) United States
(12) Patent Application Publication
(10) Pub. No.: US 2018/0231854 A1
(43) Pub. Date: Aug. 16, 2018

(54) DISPLAY DEVICE

(71) Applicant: Japan Display Inc., Minato-ku (JP)

(72) Inventors: Kayoko Miyazaki, Tokyo (JP); Arihiro Takeda, Tokyo (JP)

(73) Assignee: Japan Display Inc., Minato-ku (JP)

(21) Appl. No.: 15/896,520

(22) Filed: Feb. 14, 2018

(30) Foreign Application Priority Data
Feb. 14, 2017 (JP) 2017-024978

(51) Int. Cl. G02F 1/1362; G02F 1/1368; G02F 1/1343

(52) U.S. Cl. CPC G02F 1/136286; G02F 1/1368; G02F 1/134309; G02F 2001/13629; G02F 2201/121; G02F 2001/136295; G02F 2201/123

(57) ABSTRACT

According to one embodiment, a display device including a conductive line, the conductive line including a first conductive layer including a first upper surface, the first upper surface including a first area above an end portion and a second area located on an internal side relative to the first area, and a second conductive layer including a lower portion including a lower surface which is in contact with the second area and an upper portion above the lower portion, wherein the end portion extends to an external side in comparison with the lower surface.

### CROSS-REFERENCE TO RELATED APPLICATIONS

This application is based upon and claims the benefit of priority from Japanese Patent Application No. 2017-024978, filed Feb. 14, 2017, the entire contents of which are incorporated herein by reference.

### FIELD

Embodiments described herein relate generally to a display device.

### BACKGROUND

Various signal lines, such as source lines, are provided in a display device. Each signal line is formed by a stacked structure including a plurality of metal layers. For example, each signal line comprises a three-layer structure of titanium/aluminum/titanium or molybdenum/aluminum/molybdenum. However, aluminum has a high reflectance in comparison with other metal materials. Thus, the light emitted from an illumination device and made incident on a side of aluminum may be reflected and emitted from an aperture. Thus, for example, the contrast ratio may be decreased in a black-display state.

### BRIEF DESCRIPTION OF THE DRAWINGS

FIG. 1 is a cross-sectional view showing a structural example of a display device according to an embodiment.

FIG. 2 shows the basic structure and equivalent circuit of the display panel shown in FIG. 1.

FIG. 3 is a cross-sectional view showing the structure of a part of the display panel shown in FIG. 1.

FIG. 4 is a schematic diagram showing an example of a cross-sectional surface of a source line and a metal layer.

FIG. 5 is a schematic diagram showing an example of the source line according to another structural example of the display device of the embodiment.

FIG. 6 is a schematic diagram showing an example of the source line according to another structural example of the display device of the embodiment.

FIG. 7 is a schematic diagram showing an example of the source line according to another structural example of the display device of the embodiment.

FIG. 8 is a schematic diagram showing an example of the source line according to another structural example of the display device of the embodiment.

FIG. 9 is a schematic diagram showing an example of the source line according to another structural example of the display device of the embodiment.

### DETAILED DESCRIPTION

In general, according to one embodiment, a display device comprising a conductive line, the conductive line comprises: a first conductive layer comprising a first upper surface, the first upper surface including a first area above an end portion and a second area located on an internal side relative to the first area; and a second conductive layer comprising a lower portion comprising a lower surface which is in contact with the second area and an upper portion above the lower portion, wherein the end portion extends to an external side in comparison with the lower surface.

An embodiment will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the present embodiment, a display device is discloses as an example of electronic devices. This display device can be used for various devices such as smartphones, tablets, mobile phones, notebook computers, game consoles and virtual reality (VR) viewers. The main structure disclosed in the present embodiment can be applied to liquid crystal display devices, self-luminous display devices such as organic electroluminescent display devices, electronic paper display devices comprising an electrophoretic element, display devices to which micro-electromechanical systems (MEMS) are applied, and display devices to which electrochromism is applied.

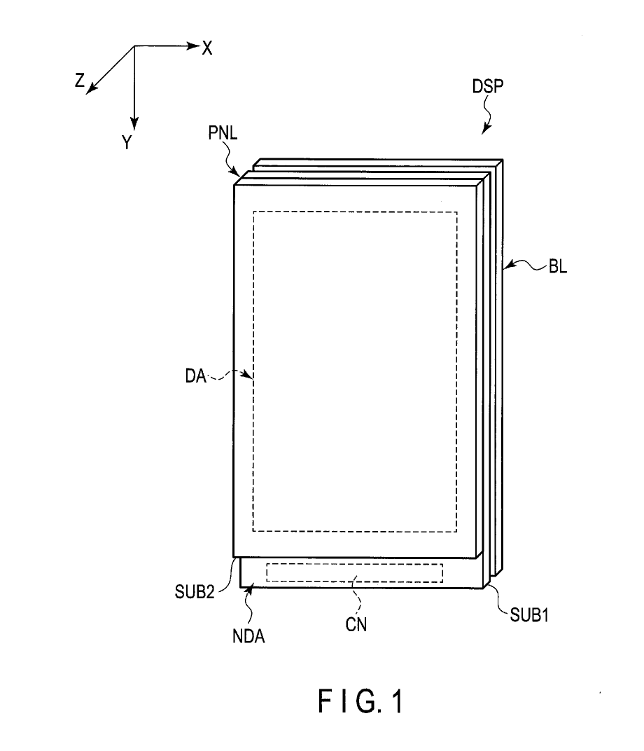

FIG. 1 is a perspective view showing a structural example of a display device DSP according to an embodiment. A first direction X, a second direction Y and a third direction Z are perpendicular to one another. However, they may intersect one another at an angle other than 90 degrees. The first direction X and the second direction Y are equivalent to directions parallel to the main surfaces of the substrates constituting the liquid crystal display device (hereinafter, simply referred to as the display device) DSP. The third direction Z is equivalent to the thickness direction of the display device DSP. FIG. 1 is a plan view of the display device DSP in the X-Y plane defined by the first direction X and the second direction Y. In the following explanation, a plan view is defined as appearance when the X-Y plane is viewed in the third direction Z.

The display device DSP comprises a display panel PNL and an illumination device EL.

The display panel PNL comprises a first substrate SUB1, a second substrate SUB2 and a liquid crystal layer (the liquid crystal layer LC described later) held between the first substrate SUB1 and the second substrate SUB2. The display panel PNL comprises a display area DA and a non-display area NDA. The display area DA is an area in which an image is displayed. The display area DA is located in substantially the center of an area in which the first substrate SUB1 faces the second substrate SUB2. The non-display area NDA is an area in which an image is not displayed. The non-display area NDA is located outside the display area DA.

The first substrate SUB1 comprises a connector CN. The connector CN comprises terminals for connecting signal supply sources such as a flexible printed circuit and an IC chip. The connector CN is located in the non-display area NDA.

The illumination device BL is provided on the rear side of the first substrate SUB1 (in other words, a side opposite to the side facing the second substrate SUB2). Various forms are applicable as the illumination device BL. For example, the illumination device BL comprises a light guide facing the first substrate SUB1, a light source such as a plurality of light-emitting diodes (LEDs) provided along an end portion of the light guide, a reflective sheet provided on one of the main-surface sides of the light guide, various optical sheets stacked on the other main-surface side of the light guide, etc.

The display panel PNL of the example shown in FIG. 1 is a transmissive display panel which displays an image by selectively transmitting the light emitted from the illumination device BL. However, the display panel PNL is not limited to this example. For example, the display panel PNL may be a reflective display panel which displays an image by selectively reflecting external light or the light emitted from an external light source, or may be a transflective display panel comprising both the transmissive display function and the reflective display function.

Here, the explanation of the detailed structure of the display panel PNL is omitted. However, a display mode using a longitudinal electric field along the normal of the display panel PNL, a display mode using an electric field inclined at a tilt with respect to the normal of the display panel PNL and a display mode using a lateral electric field along the main surfaces of the display panel PNL can be applied to the display panel PNL.

In each embodiment, the direction from the first substrate SUB1 to the second substrate SUB2 is referred to as “upward” (or toward the upper side). The direction from the second substrate SUB2 to the first substrate SUB1 is referred to as “downward” (or toward the lower side).

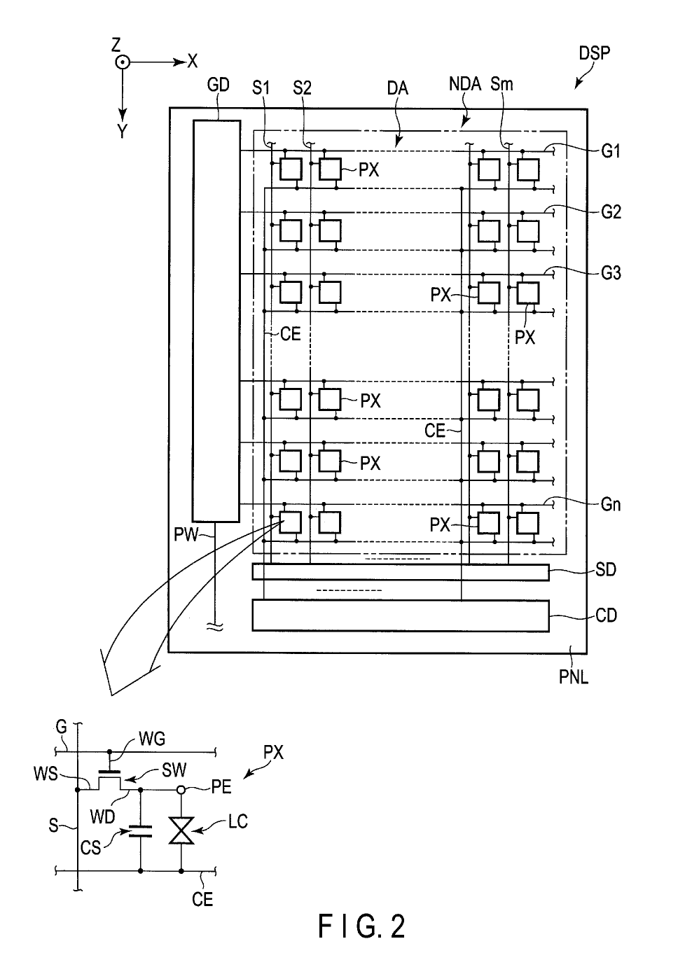

FIG. 2 shows the basic structure and equivalent circuit of the display panel PNL shown in FIG. 1.

The display panel PNL comprises a plurality of pixels PX in the display area DA. Each pixel is the minimum unit which can be individually controlled based on a pixel signal. For example, each pixel is present in an area including a corresponding switching element provided at an intersection of a gate line (scanning line) and a source line (signal line) as described later. The pixels PX are provided in matrix in the first direction X and the second direction Y. In the display area DA, the display panel PNL comprises a plurality of gate lines G (G1 to Gn), a plurality of source lines S (S1 to Sm), a common electrode CE, etc. The gate lines G extend in the first direction X and are arranged in the second direction Y. The source lines S extend in the second direction Y and are arranged in the first direction X. The gate lines G or the source lines S may not linearly extend. They may be partially curved. The common electrode CE is provided over a plurality of pixels PX. The gate lines G, the source lines S and the common electrode CE are extended to the non-display area NDA. In the non-display area NDA, the gate lines G are connected to a gate line drive circuit GD, and the source lines S are connected to a source line drive circuit SD, and further, the common electrode CE is connected to a common electrode drive circuit CD. In the non-display area NDA, the display panel PNL comprises, for example, a power line PW to which voltage is applied. The power line PW has a structure similar to that of the source lines S and the gate lines G. For example, the power line PW may be located on the same layer as the source lines S and the gate lines G. In this case, the power line PW is covered with an insulating film and is in contact with the insulating film.

Each pixel PX comprises a switching element PSW, a pixel electrode PE, a common electrode CE, a liquid crystal layer LC, etc. For example, the switching element PSW is structured by a thin-film transistor (TFT), and is electrically connected to the gate line G and the source line S. More specifically, the switching element PSW comprises a gate electrode WG, a source electrode WS and a drain electrode WD. The gate electrode WG is electrically connected to the gate line G. In the example shown in FIG. 2, the electrode electrically connected to the source line S is equivalent to the source electrode WS. The electrode electrically connected to the pixel electrode PE is equivalent to the drain electrode WD.

Each gate line G is connected to the switching elements PSW of the pixels PX arranged in the first direction X. Each source line S is connected to the switching elements PSW of the pixels PX arranged in the second direction Y. Each pixel electrode PE faces the common electrode CE, and drives the liquid crystal layer LC by the electric field generated between the pixel electrode PE and the common electrode CE. For example, storage capacitance CS is formed between the common electrode CE and the pixel electrode PE.

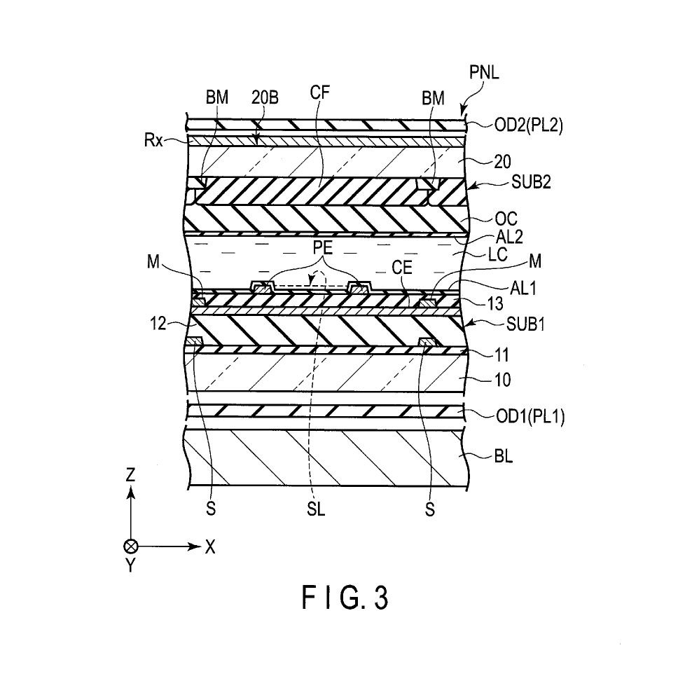

FIG. 3 is a cross-sectional view showing the structure of a part of the display panel PNL shown in FIG. 1. In the cross-sectional view, the display device DSP is cut in the first direction X. Here, this specification explains a structural example to which a fringe field switching (FFS) mode, which is one of the display modes using a lateral electric field, is applied.

The display panel PNL shown in FIG. 3 comprises a structure corresponding to a display mode mainly using a lateral electric field substantially parallel to the main surfaces of the substrates. The display panel PNL may comprise a structure corresponding to a display mode using a longitudinal electric field perpendicular to the main surfaces of the substrates, an electric field inclined with respect to the main surfaces of the substrates or a combination thereof. In a display mode using a lateral electric field, for example, a structure in which one of the first and second substrates SUB1 and SUB2 comprises both the pixel electrodes PE and the common electrode CE is applicable. In a display mode using a longitudinal electric field or an inclined electric field, for example, a structure in which the first substrate SUB1 comprises one of the group of pixel electrodes PE and the common electrode CE and the second substrate SUB2 comprises the other one of the group of pixel electrodes PE and the common electrode CE is applicable. Here, the main surfaces of the substrates are surfaces parallel to the X-Y plane.

The first substrate SUB1 comprises a supporting substrate 10, a source line S, a common electrode CE, a metal layer M, a pixel electrode PE, an insulating film 11, an insulating film 12, an insulating film 13, a first alignment film AL1, etc. In this figure, for example, a switching element, a gate line and various insulating films interposed between them are omitted.

The supporting substrate 10 is transparent. For example, the supporting substrate 10 is formed of glass such as borosilicate glass. However, the supporting substrate 10 may be formed of resin such as plastic. The insulating substrate 11 is located above the supporting substrate 10. The semiconductor layer (not shown) of the gate line and the switching element is located between the supporting substrate 10 and the insulating film 11. Although not shown in FIG. 3, the supporting substrate 10, an undercoat film, a semiconductor layer, an insulating film, the gate line and the insulating film 11 are stacked in order. The source line S is located on the insulating film 11. The insulating film 12 is located on the source line S and the insulating film 11. The common electrode CE is located on the insulating film 12. The metal layer M is located directly above the source line S, overlaps the source line S and is in contact with the common electrode CE. In the example shown in FIG. 3, the metal layer M is located on the common electrode CE. However, the metal layer M may be located between the common electrode CE and the insulating film 12. The insulating film 13 is located on the common electrode CE and the metal layer M. The pixel electrode PE is located on the insulating film 13. The pixel electrode PE faces the common electrode CE via the insulating film 13. The pixel electrode PE comprises a slit SL at a position facing the common electrode CE. The first alignment film AL1 covers the pixel electrode PE and the insulating film 13.

The gate line G, the source line S and the metal layer M are formed of a metal material such as molybdenum, tungsten, titanium and aluminum, and may have either a single-layer structure or a multi-layer structure. For example, the gate line is formed of a metal material containing molybdenum and tungsten. The source line S is formed of a metal material containing titanium and aluminum. The metal layer M is formed of a metal material containing molybdenum and aluminum. The gate line may be formed of a metal material containing molybdenum and aluminum. The common electrode CE and the pixel electrode PE are formed of a transparent conductive material such as ITO or IZO. The insulating films 11 and 13 are inorganic insulating films. The insulating film 12 is an organic insulating film.

The structure of the first substrate SUB1 is not limited to the example shown in FIG. 3. The pixel electrode PE may be located between the insulating films 12 and 13. The common electrode CE may be located between the insulating film 13 and the first alignment film AL1. In this case, the pixel electrode PE is formed like a flat plate which does not comprise a slit. The common electrode CE comprises a slit facing the pixel electrode PE. Both the pixel electrode PE and the common electrode CE may have a comb-tooth shape, and may be provided so as to be engaged with each other.

The second substrate SUB2 comprises a supporting substrate 20, a light-shielding layer BM, a color filter CF, an overcoat layer OC, a second alignment film AL2, etc.

The supporting substrate 20 is transparent. For example, the supporting substrate 20 is formed of glass such as borosilicate glass. However, the supporting substrate 20 may be formed of resin such as plastic. The light-shielding layer BM and the color filter CF are located on a side of the supporting substrate 20 so as to face the first substrate SUB1. The light-shielding layer BM partitions the pixels and is located directly above the source line S. The color filter CF faces the pixel electrode PE, and partially overlaps the light-shielding layer BM. The color filter CF includes a red color filter, a green color filter, a blue color filter, etc. The overcoat layer OC covers the color filter CF. The second alignment film AL2 covers the overcoat layer OC.

The color filter CF may be provided in the first substrate SUB1. The color filter CF may include color filters corresponding to four or more colors. In a pixel corresponding to white, a white color filter may be provided. Alternatively, an uncolored resinous material may be provided. Alternatively, an overcoat layer OC may be provided without providing a color filter.

A detection electrode Rx is located on the main surface 20B of the supporting substrate 20. The detection electrode Rx may be formed of a conductive layer containing metal or a transparent conductive material such as ITO or IZO. The detection electrode Rx may be formed by stacking a transparent conductive layer on a conductive layer containing metal. The detection electrode Rx may be formed of a conductive organic material or a dispersing element of fine conductive substances.

A first optical element OD1 including a first polarizer PL1 is located between the supporting substrate 10 and the illumination device BL. A second optical element OD2 including a second polarizer PL2 is located above the detection electrode Rx. The first optical element OD1 and the second optical element OD2 may include a retardation plate where necessary.

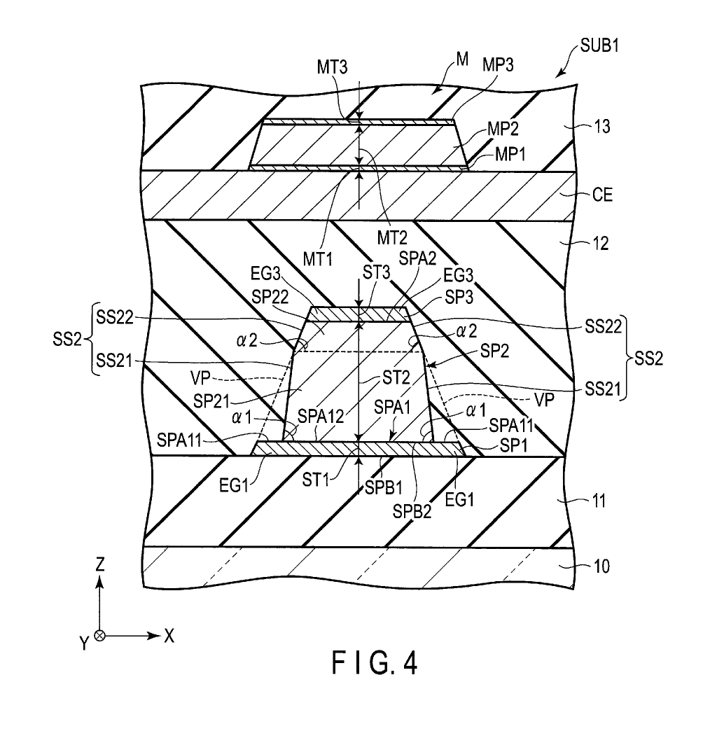

FIG. 4 is a schematic diagram showing an example of a cross-sectional surface of the source line S and the metal layer M. In FIG. 4, the structure of a part of the display panel PNL shown in FIG. 3 is enlarged.

The source line S is a conductive line comprising a stacked structure in which a first conductive layer SP1, a second conductive layer SP2 and a third conductive layer SP3 are stacked in order in the third direction Z. Thickness ST2 of the second conductive layer SP2 is greater than thickness ST1 of the first conductive layer SP1 and thickness ST3 of the third conductive layer SP3. Thickness ST1 is substantially equal to thickness ST3. The first conductive layer SP1 and the third conductive layer SP3 are formed of metal such as titanium or molybdenum. The second conductive layer SP2 is formed of metal having a reflectance greater than that of the first conductive layer SP1 and the third conductive layer SP3. For example, the second conductive layer SP2 is formed of metal such as aluminum.

The first conductive layer SP1 is located on the insulating film 11 and is in contact with the insulating film 11. The first conductive layer SP1 comprises edge portions EG1. The first conductive layer SP1 comprises an upper surface SPA1 and a lower surface SPB1. The upper surface SPA1 includes areas SPA11 above the end portions EG1, and an area SPA12 other than the areas SPA11. In the example shown in FIG. 4, the upper surface SPA1 is parallel to the X-Y plane. The area SPA12 is the area located on the internal side in comparison with the areas SPA11 in the first direction X. In the following explanation, a direction to the center of each structure refers to a direction to the internal side. The opposite direction refers to a direction to the external side.

The second conductive layer SP2 is located on the first conductive layer SP1 and is in contact with the upper surface SPA1 of the first conductive layer SP1. The second conductive layer SP2 comprises an upper surface SPA2, and a lower surface SPB2 which is in contact with the upper surface SPA1 of the first conductive layer SP1. In the example shown in FIG. 4, the upper surface SPA2 and the lower surface SPB2 are parallel to the X-Y plane. The second conductive layer SP2 comprises a lower portion SP21 which is in contact with the upper surface SPA1 of the first conductive layer SP1, and an upper portion SP22 which is in contact with the third conductive layer SP3. The lower portion SP21 includes the lower surface SPB2. The upper portion SP22 includes the upper surface SPA2. A side SS2 of the second conductive layer SP2 includes a side SS21 of the lower portion SP21, and a side SS22 of the upper portion SP22. With respect to each side SS2, at least a part of the side SS21 is located on the internal side in comparison with a plane VP passing the edge portion EG1 of the first conductive layer SP1 and the edge portion EG3 of the third conductive layer SP3. Each side SS21 is in contact with the upper surface SPA1. In the example shown in FIG. 4, the lower portion SP21 comprises a tapering plane (tapering shape) in which each side SS21 is inclined at angle al with respect to the X-Y plane (or the upper surface SPA1 or the lower surface SPB2). The upper portion SP22 comprises a tapering shape in which each side SS22 is inclined at angle α2 with respect to the X-Y plane. Angle α1 is greater than angle α2. To reduce the reflectance of the incident light from the illumination device BL, the greater each of angles α1 and α2 is, the better. However, when angles α1 and α2 are excessively great, the reflectance of the incident external light from the upper side may be great. The lower portion SP21 and the upper portion SP22 are preferably inclined at an appropriate angle so as to reduce the reflectance of the incident light from the illumination device BL and the incident external light from the upper side. For example, 70°<α1≤90°, and 40°≤α2≤70°. Each side SS21 is located on the internal side in comparison with the end portions EG1 in the first direction X.

The lower portion SP21 is in contact with the area SPA12 of the upper surface SPA1, and is not in contact with the areas SPA11. Each side SS21 is in contact with the area SPA12. In other words, the edge portions EG1 extend to the external side in comparison with the lower surface SPB2 (or the portions in which the area SPA12 is in contact with the sides SS21) in the first direction X. In this example, the second conductive layer SP2 is divided into the two layers of the lower and upper portions SP21 and SP22. However, the second conductive layer SP2 may be divided into three or more layers. In this case, in the second conductive layer SP2, the inclined angles of the sides of the layers may be different from each other.

The third conductive layer SP3 is in contact with the upper surface SPA2 of the upper portion SP22. In the example shown in FIG. 4, the edge portions EG3 of the third conductive layer SP3 are in contact with the upper surface SPA2 of the upper portion SP22. The width of the third conductive layer SP3 in the first direction X is less than that of the first conductive layer SP1 in the first direction X. The width of the third conductive layer SP3 in the first direction X may be either greater or less than that of the first conductive layer SP1 in the first direction X. The width of the third conductive layer SP3 in the first direction X may be either greater or less than that of the upper portion SP22 in the first direction X.

The source line S described above is formed by adjusting the conditions at the time of etching. For example, the source line S described above is formed by adjusting the ratio of the gaseous components etching the first conductive layer SP1 and the third conductive layer SP3 to the gaseous components etching the second conductive layer SP2. For example, when the ratio of the gaseous components etching the second conductive layer SP2 is great, the amount of the second conductive layer SP2 eliminated by etching is large.

The insulating film 12 covers the first conductive layer SP1, the second conductive layer SP2 and the third conductive layer SP3. The insulating film 12 is in contact with the sides SS2 of the second conductive layer SP2, and the third conductive layer SP3. The insulating film 12 is partially in contact with the areas SPA11 of the upper surface SPA1 of the first conductive layer SP1.

The metal layer M is a conductive line comprising a stacked structure in which a fourth conductive layer MP1, a fifth conductive layer MP2 and a sixth conductive layer MP3 are stacked in order. The metal layer M overlaps the first conductive layer SP1. For example, the width of the sixth conductive layer MP3 in the first direction X is less than that of the fourth conductive layer MP1 in the first direction X. The width of the sixth conductive layer MP3 in the first direction X may be greater than that of the fourth conductive layer MP1 in the first direction X. The fourth conductive layer MP1 extends to the external side in comparison with the first conductive layer SP1 in the first direction X. Thickness MT2 of the fifth conductive layer MP2 is greater than thickness MT1 of the fourth conductive layer MP1. Thickness MT1 of the fourth conductive layer MP1 is substantially equal to thickness MT3 of the sixth conductive layer MP3. The fourth conductive layer MP1 and the sixth conductive layer MP3 are formed of metal such as molybdenum. The fifth conductive layer MP2 is formed of metal such as aluminum. The thickness (MT1+MT2+MT3) of the metal layer M is less than the thickness (ST1+ST2+ST3) of the source line S. For example, thickness MT1 of the fourth conductive layer MP1 of the metal layer M is less than thickness ST1 of the first conductive layer SP1 of the source line S. For example, thickness MT2 of the fifth conductive layer MP2 of the metal layer M is less than thickness ST2 of the second conductive layer SP2 of the source line S. The fourth conductive layer MP1 is located on the common electrode CE and is in contact with the common electrode CE. The fifth conductive layer MP2 is located on the fourth conductive layer MP1 and is in contact with the fourth conductive layer MP1. The sixth conductive layer MP3 is located on the fifth conductive layer MP2 and is in contact with the fifth conductive layer MP2. Although not shown in FIG. 4, the same stacked structure as the source line S may be applied to the metal layer M. The structure of the source line S may be applied to the other conductive lines such as the gate lines G, the power line PW and the drain electrodes WD.

In the present embodiment, the display device DSP comprises the source lines S each comprising a stacked structure in which the first conductive layer SP1, the second conductive layer SP2 and the third conductive layer SP3 are stacked in this order. The second conductive layer SP2 includes the lower portion SP21 which is in contact with the first conductive layer SP1, and the upper portion SP22 which is in contact with the third conductive layer SP3. In each source line S, each side SS21 of the lower portion SP21 is located on the internal side in comparison with the edge portions EG1 of the first conductive layer SP1. The edge portions EG1 of the first conductive layer SP1 block the light emitted from the illumination device BL and entering the sides SS21 of the lower portion SP21. Thus, the light emitted from the illumination device BL and entering the sides SS21 of the lower portion SP21 is reduced. In this way, the light reflected on the sides SS21 and traveling to the aperture of each pixel PX can be reduced. Thus, it is possible to provide a display device capable of preventing the degradation in display quality such as the reduction in the contrast ratio and the non-uniformity in display.

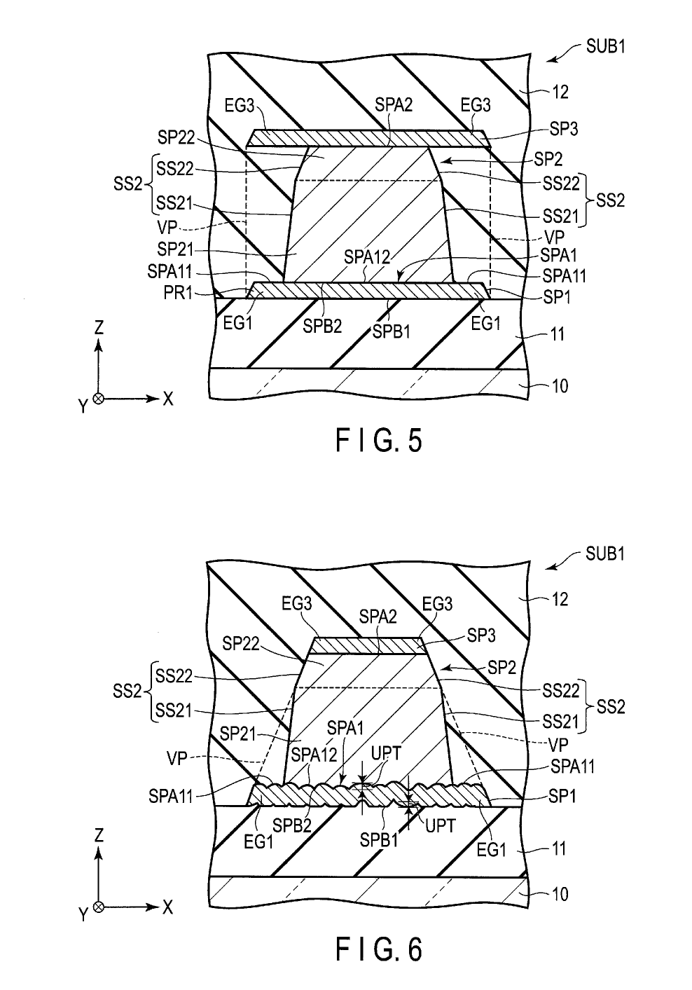

Now, this specification explains other structural examples of the present embodiment with reference to FIG. 5 to FIG. 11. In the structural examples of the present embodiment explained below, the same portions as the above embodiment are denoted by like reference numbers, detailed description thereof being omitted. Portions different from those of the above embodiment are mainly explained in detail. An effect similar to that of the above embodiment can be obtained from other embodiments.

The structural example shown in FIG. 5 is different from that in FIG. 4 in respect that the width of the third conductive layer SP3 in the first direction X is greater than that of the upper portion SP22 in the first direction X. In the example shown in FIG. 5, the width of the third conductive layer SP3 in the first direction X is greater than that of the first conductive layer SP1 in the first direction X. At this time, the edge portions EG3 of the third conductive layer SP3 are located on the external side in comparison with the edge portions EG1 of the first conductive layer SP1 in the first direction X. In this structural example, an effect similar to that of the above description can be obtained. In addition, the third conductive layer SP3 blocks the reflected light traveling to the aperture of each pixel PX. Thus, it is possible to reduce the light reflected on the sides SS2 (including the sides SS21 and the sides SS22) and traveling to the aperture of each pixel PX.

The structural example shown in FIG. 6 is different from that in FIG. 4 in respect that both the upper surface SPA1 and the lower surface SPB1 of the first conductive layer SP1 comprise an uneven shape. For example, width UPT of each uneven shape of the upper and lower surfaces SPA1 and SPB1 of the first conductive layer SP1 is greater than or equal to 5 nm and less than or equal to 20 nm. Width UPT of each uneven shape of the upper and lower surfaces SPA1 and SPB1 of the first conductive layer SP1 is preferably greater than or equal to 1 nm and less than or equal to 20 nm. The uneven shape of the upper and lower surfaces SPA1 and SPB1 of the first conductive layer SP1 is formed by, for example, roughing the insulating film which is the underlayer with plasma discharge. In this structural example, an effect similar to that of the above description can be obtained. In addition, the area in which the first conductive layer SP1 is in contact with the second conductive layer SP2 is large. Thus, the adhesion between the first conductive layer SP1 and the second conductive layer SP2 may be improved. In addition, the area in which the first conductive layer SP1 is in contact with the insulating film 11 is large. Thus, the adhesion between the first conductive layer SP1 and the insulating film 11 may be improved.

In the above description, both the upper surface SPA1 and the lower surface SPB1 of the first conductive layer SP1 comprise an uneven shape. However, the first conductive layer SP1 may comprise an uneven shape for one of the upper and lower surfaces SPA1 and SPB1. When only the upper surface SPA1 comprises an uneven shape, the adhesion between the first conductive layer SP1 and the second conductive layer SP2 may be improved. When only the lower surface SPB1 comprises an uneven shape, the adhesion between the first conductive layer SP1 and the insulating film 11 which is the underlayer may be improved.

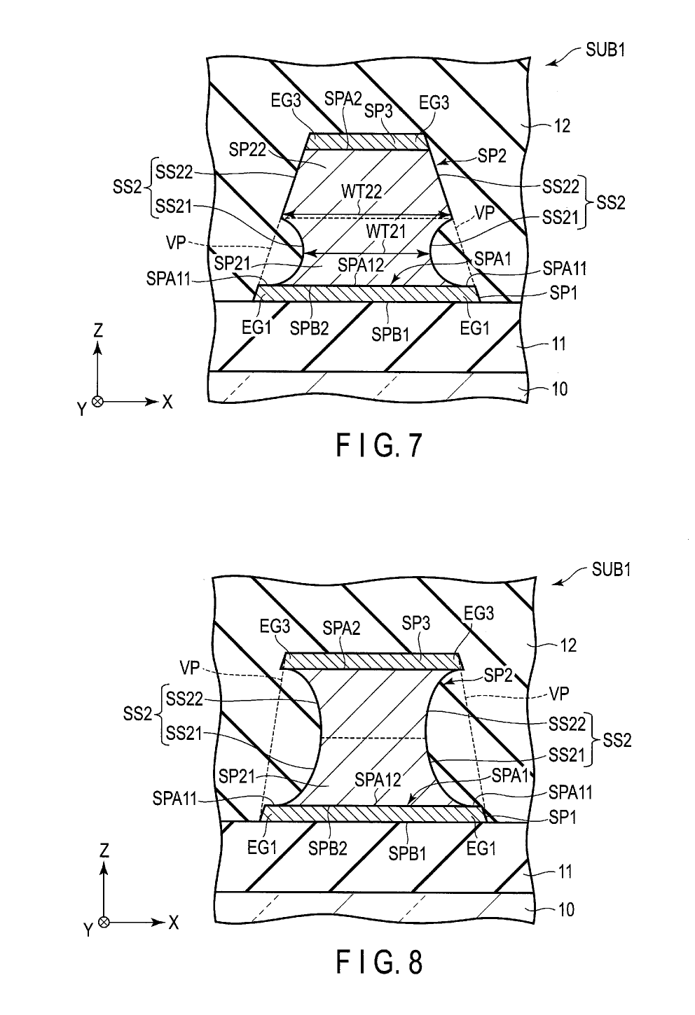

The structural example shown in FIG. 7 is different from that in FIG. 4 in respect that each side SS21 of the lower portion SP21 comprises a recess on the internal side. In the example shown in FIG. 7, each side SS21 of the lower portion SP21 comprises a surface curved on the internal side. Each side SS21 of the lower portion SP21 is located on the internal side in comparison with the edge portions EG1 of the first conductive layer SP1. Width WT21 of the lower portion SP21 in the first direction is less than width WT22 of the upper portion SP22 in the first direction. For example, width WT21 is the width of the lower portion SP21 between the deepest portions of the recesses on the internal side in the first direction X. Width WT22 is the greatest width of the upper portion SP22 in the first direction X. Width WT21 is less than the width of the first conductive layer SP1 in the first direction X. Width WT22 may be either less or greater than the width of the first conductive layer SP1 in the first direction X. As long as the sides SS21 of the lower portion SP21 are partially located on the internal side in comparison with the planes VP, the lower portion SP21 may be in contact with the areas SPA11 of the upper surface SPA1 of the first conductive layer SP1. Each side SS22 of the upper portion SP22 may have either a tapering plane or curved surface. In this structural example, an effect similar to that of the above description can be obtained. In addition, as each side SS21 of the lower portion SP21 comprises a recess on the internal side, the light emitted from the illumination device BL and entering the sides SS21 is reflected to the lower side. Thus, it is possible to reduce the reflected light traveling to the aperture of each pixel PX.

The structural example shown in FIG. 8 is different from that in FIG. 7 in respect that each side SS2 (including SS21 and SS22) of the second conductive layer SP2 comprises a recess on the internal side. In the example shown in FIG. 8, each side SS2 comprises a surface curved on the internal side. Each side SS21 of the lower portion SP21 is located on the internal side in comparison with the edge portions EG1 of the first conductive layer SP1. As long as the sides SS21 of the lower portion SP21 are partially located on the internal side in comparison with the planes VP, the lower portion SP21 may be in contact with the areas SPA11 of the upper surface SPA1 of the first conductive layer SP1. In this structural example, an effect similar to that of the above description can be obtained. In addition, as each side SS2 of the second conductive layer comprises a recess on the internal side, the light emitted from the illumination device BL and entering the sides SS22 of the upper portion SP22 is reflected to the lower side. The edge portions EG1 of the first conductive layer SP1 block the light emitted from the illumination device BL and entering the sides SS21 of the lower portion SP21. Thus, it is possible to further reduce the reflected light traveling to the aperture of each pixel PX in comparison with the above embodiment.

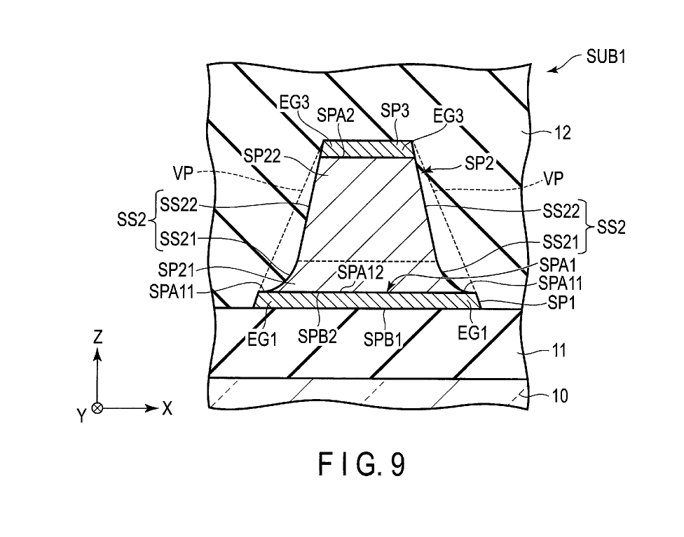

The structural example shown in FIG. 9 is different from that in FIG. 4 in respect that each side SS21 of the lower portion SP21 of the second conductive layer SP2 comprises a curved surface and each side SS22 of the upper portion SP22 comprises a tapering plane. In the example shown in FIG. 9, each side SS21 of the lower portion SP21 comprises a gently-curved surface, and each side SS22 of the upper portion SP22 comprises a plane which is steeply inclined. The sides SS21 of the lower portion SP21 and the sides SS22 of the upper portion SP22 are located on the internal side in comparison with the planes VP. The sides SS21 of the lower portion SP21 are located on the internal side in comparison with the edge portions EG1 of the first conductive layer SP1. As long as the sides SS21 of the lower portion SP21 are partially located on the internal side in comparison with the planes VP, the lower portion SP21 may be in contact with the areas SPA11 of the upper surface SPA1 of the first conductive layer SP1. In this structural example, an effect similar to that of the above description can be obtained. In this example, each side SS21 of the lower portion SP21 comprises a curved surface, and further, each side SS22 of the upper portion SP22 comprises a tapering plane. However, each side SS2 of the second conductive layer SP2 may comprise a curved surface from the side SS21 of the lower portion SP21 to the side SS22 of the upper portion SP22.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising a conductive line,
the conductive line comprising:
a first conductive layer comprising a first upper surface, the first upper surface including a first area above an end portion and a second area located on an internal side relative to the first area; and
a second conductive layer comprising a lower portion comprising a lower surface which is in contact with the second area and an upper portion above the lower portion, wherein
the end portion extends to an external side in comparison with the lower surface.

2. The device of claim 1, wherein
a first side of the lower portion is inclined at a first angle with respect to a first plane,
the first plane is parallel to the lower surface,
the first angle is greater than a second angle of a second side of the upper portion, and
the second side is inclined with respect to the first plane.

3. The device of claim 2, wherein
the first angle is greater than 70° and less than or equal to 90°, and
the second angle is greater than 40° and less than or equal to 70°.

4. The device of claim 1, wherein
a first width of the lower portion is less than a second width of the upper portion.

5. The device of claim 1, wherein
a first side of the lower portion comprises a recess.

6. The device of claim 5, wherein
a second side of the upper portion comprises a recess.

7. The device of claim 1, wherein
a first side of the lower portion includes a curved surface.

8. The device of claim 7, wherein
a second side of the upper portion is a flat surface.

9. The device of claim 1, wherein
the first upper surface comprises an uneven shape.

10. The device of claim 9, wherein
a width of the uneven shape is greater than or equal to 1 nm and less than or equal to 20 nm.

11. The device of claim 1, further comprising
a third conductive layer which is in contact with a second upper surface of the upper portion.

12. The device of claim 11, wherein
the first conductive layer and the third conductive layer are formed of titanium or molybdenum, and
the second conductive layer is formed of aluminum.

13. The device of claim 12, wherein
the conductive line is at least one of a source line, a gate line and a power line.

14. The device of claim 13, further comprising
an insulating film covering the first conductive layer, the second conductive layer and the third conductive layer.

15. The device of claim 14, wherein
the insulating film is in contact with the first area.

16. The device of claim 15, further comprising
a metal layer located on the insulating film, wherein
the metal layer overlaps the first conductive layer.

17. The device of claim 16, wherein
the metal layer has a thickness less than a thickness of the conducive line.

18. The device of claim 17, wherein
the metal layer is a conductive line in which a fourth conductive layer, a fifth conductive layer and a sixth conductive layer are stacked in order, and
the fourth conductive layer has a thickness less than a thickness of the first conductive layer.
